(19) United States
(12) Patent Application Publication
(10) Pub. No.: US 2025/0301489 A1
(43) Pub. Date: Sep. 25, 2025

(54) Methods and Apparatus for TVWS Based Backhaul Coordination

(71) Applicant: Parallel Wireless, Inc., Nashua, NH (US)

(72) Inventors: Netanel Gabizon, Salit (IL); Steven Paul Papa, Windham, NH (US); Baruch Navon, Alumot (IL)

(21) Appl. No.: 19/088,651

(22) Filed: Mar. 24, 2025

Related U.S. Application Data
(60) Provisional application No. 63/568,714, filed on Mar. 22, 2024.

(51) Int. Cl. H04W 72/51; H04L 43/0882; H04W 72/0446

(52) U.S. Cl. CPC H04W 72/51; H04L 43/0882; H04W 72/0446

(57) ABSTRACT

In a first aspect, a first television white space (TVWS)-capable wireless backhaul terminal (TVWS WBT) is provided. The first TVWS-capable WBT comprises (1) a backhaul interface configured to receive backhaul traffic from a core network using Wi-Fi waveforms on one or more TVWS bands; and a scheduler configured to allocate resources for communicating the backhaul traffic to at least a second TVWS-capable WBT and a third TVWS-capable WBT coupled to the first TVWS-capable WBT. The second TVWS-capable WBT is coupled to first base station and configured to provide backhaul traffic for the first base station to the first base station, and the third TVWS-capable WBT is coupled to a second base station and configured to provide backhaul traffic for the second base station to the second base station. Numerous other aspects are provided.

### CROSS-REFERENCE TO RELATED APPLICATIONS

This application claims priority under 35 U.S.C. § 119 (e) to U.S. Provisional Pat. App. No. 63/568,714 filed Mar. 22, 2024 titled “TVWS BASED BACKHAUL COORDINATION OVER MANAGED WI-FI NETWORK” which is hereby incorporated by reference in its entirety for all purposes.

### BACKGROUND

Cellular base stations require a high-bandwidth connection to a core network, called backhaul, for sending and receiving data to and from a cellular network provider's network, the public Internet, and other networks. Cellular base stations also typically utilize a connection called fronthaul, which is defined as the connection between the remote radio head (RRH), which contains the radiating element of the cellular base station, and the baseband unit (BBU). In a 5G cloud RAN architecture, the BBU is split into two functional units, a centralized unit (CU) and a distributed unit (DU); in this architecture fronthaul is defined as the connection between the active antenna unit (AAU) and the DU, while midhaul is defined as the connection between the DU and the CU, and backhaul is defined as the connection between the CU and the core network.

In a separate subject area, Wi-Fi is a wireless networking technology characterized by carrier sense multiple access (CSMA). Wireless nodes listen to a wireless carrier to determine whether or not they are able to transmit; when the carrier is clear, a node is clear to transmit. Some versions of CSMA use special packets, such as acknowledge (ACK)/clear to send (CTS)/request to send (RTS) packets, to control access. Modern versions of Wi-Fi use CSMA/CA (CSMA with collision avoidance), which automatically handles some of the challenges of CSMA. Still more recent versions of Wi-Fi, including Wi-Fi 6 (802.11ax) and subsequent versions, use orthogonal frequency division multiple access (OFDMA), which is a centrally coordinated multiple access system also used in cellular technologies such as 4G and 5G. Wi-Fi access points, while inexpensive, require coordination in order to be used together; for example, a typical challenge for Wi-Fi, even with a large number of access points, is to provide reliable coverage for users in a crowded area, such as a sports stadium. A standard that is used in the home environment is Wi-Fi EasyMesh, based on IEEE 1905.1. Another meshing standard for Wi-Fi is IEEE 802.11s.

In another separate subject area, TV white space (TVWS) is a portion of the electromagnetic spectrum between 470 MHz to 790 MHz, previously used to buffer between analog television signals. When used for digital transmission, these frequencies are very desirable as they pass through walls and propagate for long distances, and as they also have the capability to transmit relatively high amounts of data. In the U.S., TVWS is coordinated by TVWS spectrum access system (SAS) or CBRS databases, such as a database operated by Google.

### SUMMARY

In one aspect, a television white space (TVWS)-capable wireless backhaul terminal (TVWS-capable WBT) is disclosed. The TVWS-capable WBT comprises (1) a TVWS radio interface coupled with a shared wireless medium, the shared wireless medium being shared with a second TVWS-capable WBT; (2) a backhaul interface coupled with an active antenna unit (AAU) cellular radio access network (RAN) device; and (3) a control channel in communication with the second TVWS-capable WBT for coordination of the shared wireless medium, wherein the TVWS radio interface is configured to provide backhaul for the AAU RAN device.

In another aspect, a first TVWS-capable WBT is provided. The first TVWS-capable WBT includes (1) a backhaul interface configured to receive backhaul traffic from a core network using Wi-Fi waveforms on one or more TVWS bands; and (2) a scheduler configured to allocate resources for communicating the backhaul traffic to at least a second TVWS-capable WBT and a third TVWS-capable WBT coupled to the first TVWS-capable WBT. The second TVWS-capable WBT is coupled to first base station and configured to provide backhaul traffic for the first base station to the first base station, and the third TVWS-capable WBT is coupled to a second base station and configured to provide backhaul traffic for the second base station to the second base station.

In another aspect, another TVWS-capable WBT is provided. Such a TVWS-capable WBT comprises (1) a first interface configured to receive, on a shared control channel, at least one of backhaul traffic or control frames from a centralized TVWS-capable WBT, wherein the centralized TVWS-capable WBT communicates with a core network using Wi-Fi waveforms on one or more TVWS bands; and (2) a second interface configured to send the backhaul traffic to a base station coupled to the TVWS-capable WBT.

In yet another aspect, a method of coordinating backhaul traffic communication, is provided. The method comprising (1) receiving, by a backhaul interface of a first television white space (TVWS)-capable wireless backhaul terminal (TVWS-capable WBT), Wi-Fi waveforms on one or more television white space (TVWS) bands including backhaul traffic from a core network; and (2) allocating resources, by a scheduler of the first TVWS-capable WBT, for communicating the backhaul traffic to at least a second TVWS-capable WBT and a third TVWS-capable WBT coupled to the first TVWS-capable WBT, wherein the second TVWS-capable WBT is coupled to a first base station and configured to provide backhaul traffic for the first base station to the first base station, and the third TVWS-capable WBT is coupled to a second base station and configured to provide backhaul traffic for the second base station to the second base station. Numerous other aspects are provided.

### BRIEF DESCRIPTION OF THE DRAWINGS

FIG. 1 is a schematic diagram 100 including an apparatus for TVWS based backhaul coordination in accordance with some embodiments.

FIG. 2 is a further schematic diagram 200 including an apparatus for TVWS based backhaul coordination in accordance with some embodiments.

FIG. 3 is a schematic diagram of a multi-RAT RAN deployment architecture in accordance with some embodiments.

FIG. 4 is a flow diagram of an example method of coordinating backhaul traffic communication in accordance with some embodiments.

FIG. 5 is a flow diagram of an example method of backhaul traffic communication in accordance with some embodiments.

### DETAILED DESCRIPTION

It is desirable to have cellular base stations with wireless backhaul. The characteristics of TVWS also lend themselves to providing wireless backhaul. The present application describes systems and methods for providing wireless backhaul using TVWS band technology, more specifically, usage of managed Wi-Fi network (multiple Wi-Fi APs connected with a shared control interface), in order to provide cellular backhaul/midhaul channel over TVWS frequencies. For multi-tenant management, the ability to use a TVWS or non-TVWS Wi-Fi AP with centralized/integrated multi-band management for backhaul can be advantageous as well.

TVWS uses a control scheme similar to Wi-Fi, as is specified in the IEEE 802.11af standard, which specification is hereby incorporated by reference. A control channel can be managed to provide backhaul for the cellular network RAN (e.g., 4G, 5G, etc.), and the control channel may be shared among tenancies and multiple RANs at a single tower/pole to backhaul multiple RANs at a single site, in some embodiments. The shared control channel will secure the minimal bandwidth required to share bandwidth requirements, control and telemetry communication. As Wi-Fi uses a central scheduler, bandwidth and QoS requirements will be used by central control unit to allocate spectral resources based on demand and defined quality of service per backhaul requesting node, in some embodiments.

The present disclosure is broken up into three parts: TVWS-capable backhaul wireless terminal or access point (AP) hardware and interoperability.

### Hardware

Systems and methods are described for providing hardware, henceforth called a TVWS-capable backhaul wireless terminal, for use with existing cellular base station technology, including 4G LTE eNodeBs and 5G gNodeBs, OpenRAN compliant remote radio heads (RRHs) and active antenna units (AAUs), and including various 3GPP-compliant fronthaul functional splits (Option 7, Option 8, etc.) Additionally, the present solutions can also be used to provide fronthaul, where latency limitations of the specific radio access technology (RAT) are able to be met; for example, as latency requirements are lower for 2G, the present systems and methods could be used to provide fronthaul for a 2G antenna unit coupled over TVWS to a 2G baseband processor or baseband unit (BBU) using an Option 7 functional split. In some embodiments, multiple RATs may be supported for backhaul at once; in other embodiments, the supported RAT may be based on latency characteristics of the channel.

A TVWS-capable backhaul wireless terminal may, in some embodiments, use a Wi-Fi (802.11) waveform of a desired variety of Wi-Fi, such as 802.11ax, and may be adapted to use the TVWS bands. TVWS uses various bands between 470 MHz and 790 MHz, and although Wi-Fi typically operates in the 2.4 GHz, 5 GHZ, and 6 GHz bands, some Wi-Fi standards, notably 802.11af, provide support for the TVWS spectrum. 802.11af uses an orthogonal frequency-division multiplexing (OFDM) physical layer (PHY) and supports a maximum of 426.7 Mbps in 6 and 7 MHz channels or 568.9 Mbps for 8 MHz channels. Additional bandwidth may be possible, in some embodiments. Wi-Fi 6 and/or Wi-Fi 7 may be supported, in some embodiments, or enhanced versions thereof that support TVWS bands may be provided, in some embodiments.

802.11af cognitive radio technology, and/or the use of CBRS/SAS enhanced behavior, can be used to designate which frequencies are suitable for transmission, in some embodiments. A central controller, described below, may perform CBRS/SAS negotiation to obtain clearance to transmit on specified bands, in some embodiments. In some embodiments, the central controller node may provide both a scheduling function and a backhaul data routing function.

### Interoperability

Interoperability as used herein describes the protocol between the TVWS-capable backhaul wireless terminals and a centralized coordination function and backhaul point. Interoperability functionality provides coordination between TVWS-capable backhaul wireless terminals to ensure multiple TVWS-capable backhaul wireless terminals do not contest with each other for bandwidth. By analogy to Wi-Fi, each TVWS-capable backhaul wireless terminal shares the wireless channel, in some embodiments. But instead of a carrier sense protocol, in some embodiments a centralized scheduler is used and each TVWS-capable backhaul wireless terminal is assigned slots for communication.

In a simple embodiment, each TVWS-capable backhaul wireless terminal may be given a fixed equal slice of the available bandwidth to transmit on, and each TVWS-capable backhaul wireless terminal is thus encouraged to transmit on a round robin basis; more sophisticated allocations may involve additional factors as follows. In some embodiments, the scheduler may take into account the needs of each individual TVWS-capable backhaul wireless terminal, including bandwidth, latency, QoS, synchronous or asynchronous, etc. For example, if one TVWS-capable backhaul wireless terminal has a greater need for backhaul, then other TVWS-capable backhaul wireless terminals may be given fewer slots for communication. The scheduler may take into account historical patterns or may use artificial intelligence (AI) or machine learning (ML) to perform scheduling, in some embodiments.

Each TVWS-capable backhaul wireless terminal may register its backhaul needs with the scheduler, in some embodiments; this may include a session-level listing of connections and their approximate backhaul bandwidth needs and latency guarantees, or may be one or more QoS parameters such as QCIs, 5QIs, DiffServ identifiers or equivalent, in some embodiments. Load may be monitored by a central terminal or a primary terminal, which may be one of the TVWS-capable backhaul wireless terminals or may be a centralized scheduler, and the monitored load may be used to provide load balancing, in some embodiments. Other techniques, such as prebalancing, static or dynamic balancing per terminal, airtime fairness for reducing negative impacts of terminals with lower signal to noise ratio on the overall performance of the system, proactive load balancing, band steering, or other techniques may be incorporated as part of the scheduler, in some embodiments. The centralized scheduler may have an API or accept messages or may be able to receive decision-making parameters, in some embodiments, and these messages may be incorporated into subsequent scheduling decisions.

The scheduler may operate in an approximate period of 1 ms, in some embodiments. This is a generally suitable amount of time that is sufficiently low latency to provide good adaptability for an access point providing UE access at 4G LTE speeds, as well as any slower speeds. Individual scheduling operations may be performed and sent out to the identified TVWS-capable backhaul wireless terminal within 1 ms, in some embodiments, while certain other operations, such as requests for bandwidth that are non-urgent or non-synchronous, may be performed within an approximate general latency of 100 ms, and may be performed in any arbitrary order as decided by the scheduler, in some embodiments.

The scheduler may allocate chunks of time, frames or portions of frames, frequencies, resource blocks, QAM points, or other discrete spectrum resources corresponding to the TVWS backhaul links, in some embodiments. The scheduler may perform allocations in coordination with CBRS/SAS functionality, in some embodiments, such that allocations are cleared by the CBRS/SAS for regulatory compliance. The scheduler may take into account spatial multiplexing and may designate different target TVWS-capable backhaul wireless terminals for different spatial streams, which may take into account preconfigured or dynamically configured locations for the individual TVWS-capable backhaul wireless terminals, in some embodiments. The scheduler may coordinate among the different TVWS-capable backhaul wireless terminals to select bandwidths, frequencies, timeslots, etc. that can be effectively shared among each of the multiple TVWS-capable backhaul wireless terminals connected to the scheduler; this may or may not involve requiring the TVWS-capable backhaul wireless terminals to use the same bandwidths, frequencies, timeslots or other configurations, in some embodiments.

A shared control channel may be provided between TVWS-capable backhaul wireless terminals, in some embodiments. A common clock base may be shared among the TWVS backhaul wireless terminals, in some embodiments, and may be shared via control and/or management frames; this may be based on GPS or IEEE 1588, in some embodiments. Automatic channel assignment and automatic bandwidth assignment may be provided to the TVWS-capable backhaul wireless terminals, in some embodiments, and via a shared control channel, in some embodiments.

The TVWS-capable backhaul wireless terminals are configured to connect to a centralized scheduler using a shared control channel, in some embodiments, which in some embodiments uses synchronization among the TVWS-capable backhaul wireless terminals to cause each TVWS-capable backhaul wireless terminal to activate at a particular time and listen to a control channel message. A downlink control channel and an uplink control channel may be provided, in some embodiments. In some embodiments, each TVWS-capable backhaul wireless terminal may have its own designated control channel or pair of control channels.

Synchronization may be achieved by using a synchronization signal, by using GPS or IEEE 1588, or another method, in some embodiments. Synchronization is performed periodically, in some embodiments. Synchronization and the use of an active control channel is particularly important given the regulatory framework for TVWS, as a given CBRS/SAS spectrum authorization may only be valid for a limited time.

In some embodiments, TVWS-capable backhaul wireless terminals from different vendors may be configured to share a single coordination node and may share the control channel. In some embodiments, multiple network operators may share one or more individual TVWS-capable backhaul wireless terminals (multi-tenancy) and the TVWS-capable backhaul wireless terminals may use their spectrum, timeslot etc. on the backhaul connection for each of the multiple network operators; this may be controlled or configured at the TVWS-capable backhaul wireless terminal or at the scheduler, in some embodiments. The scheduler may perform allocation of the available backhaul with an algorithm to ensure fair usage by each network operator in a multi-tenancy deployment, in some embodiments.

In some embodiments, a 5G RAN intelligent controller (RIC) may be used in conjunction with the centralized scheduler, or the RIC may perform the functions of the centralized scheduler. In some embodiments, meshing may be used between TVWS-capable backhaul wireless terminals to provide control channel connectivity over increased distances, at the cost of some latency. In some embodiments, a range of 10 km or more between the TVWS-capable backhaul wireless terminals and the scheduler node may be provided.

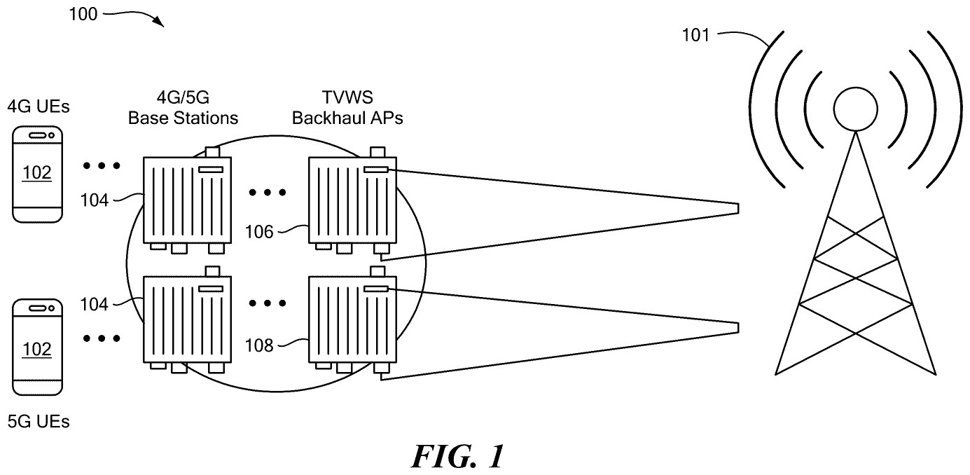

FIG. 1 is a schematic diagram 100 in accordance with some embodiments, showing standard 4G/5G UEs 102 attached to 4G/5G base stations 104 (which may be 4G base stations or 5G base stations). The 4G or 5G base stations are each coupled to a TVWS-capable backhaul wireless terminal (e.g., capable of using TVWS, TVWS and cellular, TVWS and Wi-Fi, or TVWS and Wi-Fi and cellular for backhaul), each of which is in communication with a TVWS-capable radio tower 101, in some embodiments, the TVWS-capable radio tower providing backhaul bandwidth capability for the TVWS-capable backhaul wireless terminals or access points (APs) 106, 108. The base stations may use active antennas for cellular and the TVWS-capable backhaul wireless terminals may use passive antennas, in some embodiments. The base stations and the TVWS-capable backhaul wireless terminals may be separate (linked via wire or cable or fiber) or integrated, in some embodiments. The base stations may be active antenna units (AAUs) with some of its radio processing power located onboard and/or offboard, in some embodiments. A baseband unit (BBU; not shown) may be located offboard, in some embodiments. The TVWS-capable backhaul wireless terminals may include both TVWS antennas along with cellular and/or other antennas in the backhaul wireless terminals, in some embodiments. The TVWS-capable backhaul wireless terminals can use low-cost passive TVWS antennas together with active cellular antennas, in some embodiments.

An AAU may coordinate with the TVWS-capable backhaul wireless terminal to enable the centralized scheduler to appropriately determine the type or level of traffic; this coordination may be anywhere from the TVWS-capable backhaul wireless terminal passively monitoring the amount of traffic, to performing envelope inspection (shallow packet inspection or SPI) to deep packet inspection (DPI), to more specific messaging back and forth between the AAU and the TVWS-capable backhaul wireless terminal with information about one or more of: the number of users, current and expected load, the type of traffic, including synchronous or non-synchronous and latency-dependent or non-latency-dependent, number of data sessions, individual data sessions, using an API and at periodic intervals for more effective coordination, in some embodiments. In some embodiments the active antenna unit may be coupled with a passive TVWS-capable backhaul wireless terminal and the passive TVWS-capable backhaul wireless terminal may use a passive antenna system with passive antenna elements and the active AAU may use an active antenna system with active antenna elements. A deployment may involve a directional TVWS antenna, as a TVWS deployment may involve fixed wireless links, similar to microwave links, in some embodiments. In some embodiments, the coordinating node may use a large TVWS antenna, such as a TV broadcasting tower, to send data to the TVWS-capable backhaul wireless terminals; in some embodiments the wireless links may be asymmetric. The TVWS-capable backhaul wireless terminal may be physically integrated with the AAU, in some embodiments. In some embodiments, the AAU may include a passive TVWS antenna, and thereby may integrate a TVWS-capable backhaul wireless terminal or TVWS-capable backhaul wireless terminal capability, in some embodiments. The AAU can use low-cost passive TVWS antennas together with active cellular antennas, in some embodiments.

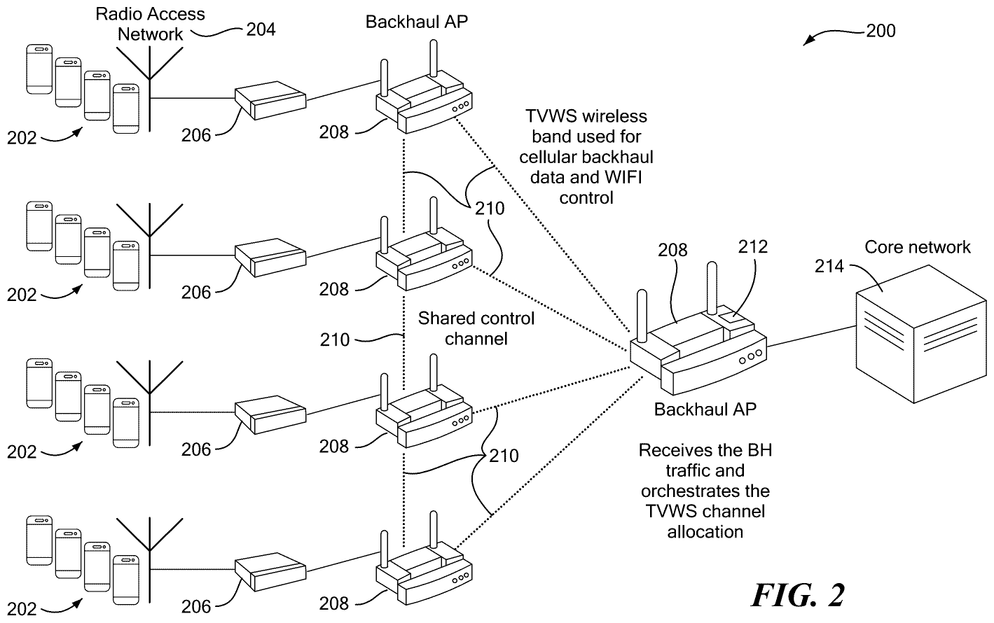

FIG. 2 is a further schematic diagram 200 in accordance with some embodiments, showing UEs 202 attached to radio access networks (RANs) 204, which may be 4G, 5G, or another radio access technology (RAT). The base stations 206 are each coupled to a TVWS-capable backhaul wireless terminal 208, and the TVWS-capable backhaul wireless terminals are coupled to each other using a shared control channel 210. The TVWS-capable backhaul wireless terminals use TVWS bands for both cellular backhaul data and the control channel for the TVWS-capable backhaul wireless terminals; the TVWS-capable backhaul wireless terminals may also be capable of Wi-Fi or may use all or some of the Wi-Fi standards, including Wi-Fi control channels, in some embodiments. The Wi-Fi control algorithms and logic can be supplemented or enhanced to manage TVWS as well as Wi-Fi backhaul channels, in some embodiments. The TVWS-capable backhaul wireless terminals may use Wi-Fi multiple access technologies, in some embodiments. A centrally located TVWS-capable backhaul wireless terminal 212, which may be the same as the TVWS-capable backhaul wireless terminals collocated at the base stations or which may be a different type of TVWS-capable backhaul wireless terminal, receives the backhaul traffic and orchestrates the TVWS channel allocation for the plurality of TVWS-capable backhaul wireless terminals. The centrally located TVWS-capable backhaul wireless terminal is in communication with one or more operator core networks 214 for providing backhaul network routing, in some embodiments. The centrally located TVWS-capable backhaul wireless terminal is able to coordinate with SAS or other TVWS coordination functions and facilities, which may differ based on region and country, in some embodiments. The centrally located TVWS-capable backhaul wireless terminal may be a specialized TVWS UE or CPE (customer premises equipment), in some embodiments, configured to interoperate with the AAU passive TVWS backhaul antennas, in some embodiments. In some embodiments, the AAU may use an appropriate backhaul type based on operator core network capability, bandwidth requirements, backhaul data type requirements, or other factors.

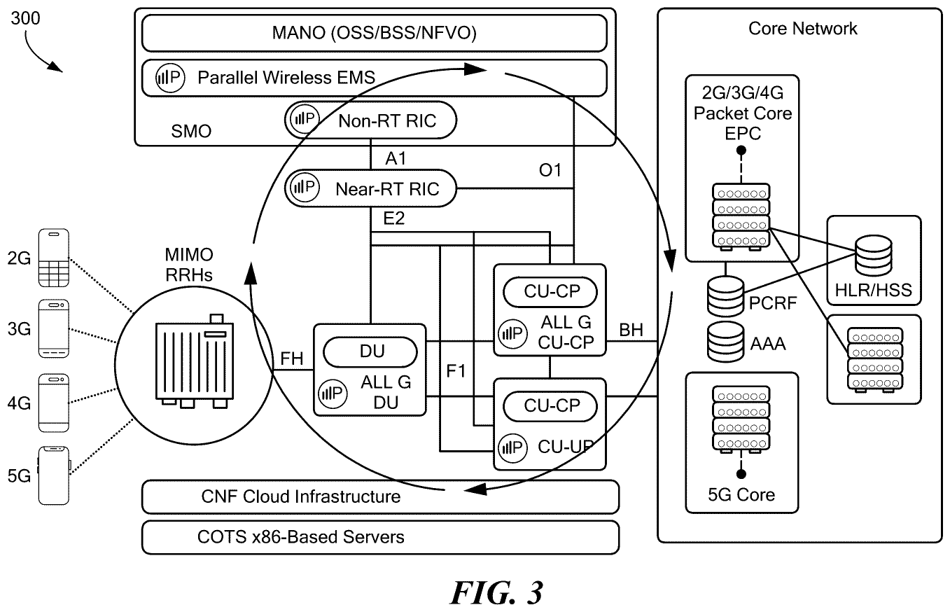

FIG. 3 is a schematic diagram of a multi-RAT RAN deployment architecture 300, in accordance with some embodiments. Multiple generations of UE are shown, connecting to RRHs that are coupled via fronthaul to an all-G DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. The near-RT RIC is capable of interoperating with not just 5G but also 2G/3G/4G. The MIMO RRHs may be active antenna units (AAUs) with some of its radio processing power located onboard and/or offboard, in some embodiments.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT.

### Further Embodiments

Where TVWS is described herein, other similar unmanaged spectrum may be used as a wireless backhaul medium, in some embodiments. Multi-tenancy, e.g., multiple wireless operators sharing the base stations and capacity on the TVWS-capable backhaul wireless terminals, may be enabled, in some embodiments; centralized management of the TVWS-capable backhaul wireless terminals is used to provide multitenancy.

In some embodiments, Wi-Fi is used as the radio waveform and protocol for TVWS access as described herein.

Distributed backhaul support is enabled using multiple TVWS-capable backhaul wireless terminals, in some embodiments, by allowing multiple TVWS-capable backhaul wireless terminals to provide backhaul (or midhaul or fronthaul) for a single base station, in some embodiments. TVWS-capable backhaul wireless terminals may be enabled to use mesh networking technology to share available bandwidth to the centralized TVWS-capable backhaul wireless terminal, or to provide resiliency in case of poor routing or poor signal environments, in some embodiments. Midhaul over wireless (Wi-Fi, TVWS) can be enabled between a DU and a CU, in some embodiments.

Management of the network may be performed from a network control user interface (single pane of glass), in some embodiments, where load and usage is able to be monitored from a remote site and an operator is able to adjust network parameters, including backhaul scheduling parameters and load balancing parameters, in some embodiments.

Multiple use cases and QCIs may be supported by the TVWS-capable backhaul wireless terminals, in some embodiments, Specifically, voice, video, teleconferencing, VOIP, and other similar latency-dependent use cases may be given priority according to methods known in the art, in some embodiments, and the degree of priority given may be adjusted along with other parameters at the centralized scheduler, in some embodiments. The scheduler may take into account the latency needs of UEs connected to the TVWS-capable backhaul wireless terminals, for example, by prioritizing backhaul needed for synchronous connections like videoconferencing or phone calls, and deprioritizing bulk Internet data connections, in some embodiments. Guaranteed bandwidth can be provided to a certain node or to a certain tunnel or to a certain use case, in some embodiments.

Scheduling may be provided at various granularities and latencies, such as 1 ms, 10 ms, 100 ms, in some embodiments. Lower latencies may be enabled for shorter distances and higher latencies may be paired with greater sizes of chunks of bandwidth that are allocated at once, in some embodiments. Bandwidth/quality of Service (QOS) can be guaranteed or allocated by the scheduler according to a combination of IEEE 802.11af (TVWS) and IEEE 802.11n/ac/be/bn and IEEE 802.11ax, as needed, in some embodiments, with each IEEE standard being used to provide access control and QoS for each respective radio frequency band, the necessary IEEE standards being incorporated by reference herein for all purposes. Future versions of IEEE 802.11 Wi-Fi standards are also contemplated as being possible to integrate with the present disclosure, in some embodiments.

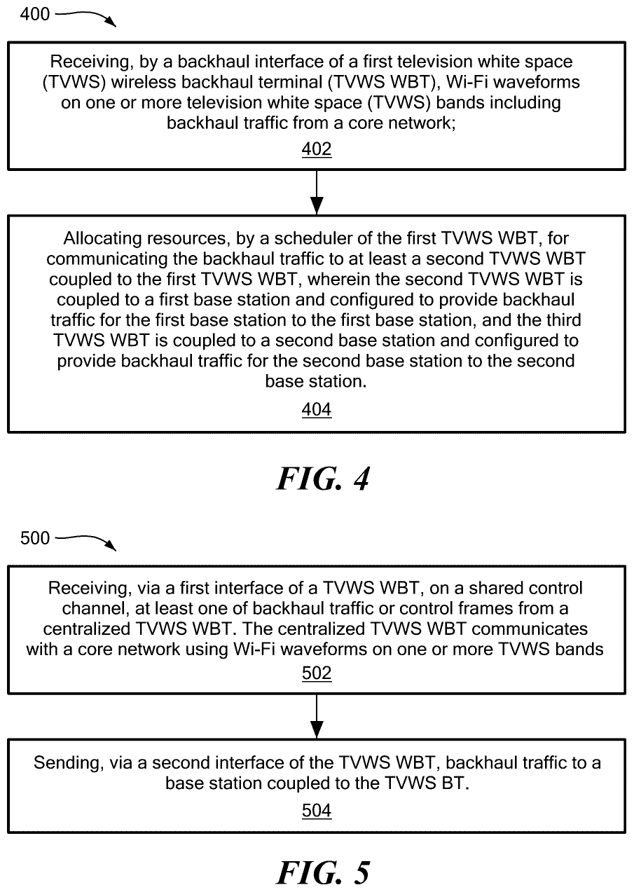

A flow chart of a particular embodiment of the presently disclosed method is depicted in FIG. 4. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language or hardware implementation. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 4, an example embodiment of a method 400 of coordinating backhaul traffic communication. The method 400 includes, as shown in processing block 402 receiving, by a backhaul interface of a first television white space (TVWS) wireless backhaul terminal (TVWS WBT), Wi-Fi waveforms on one or more television white space (TVWS) bands including backhaul traffic from a core network. Processing block 404 shows allocating resources, by a scheduler of the first TVWS WBT, for communicating the backhaul traffic to at least a second TVWS WBT and a third TVWS WBT coupled to the first TVWS WBT. The second TVWS WBT is coupled to a first base station and configured to provide backhaul traffic for the first base station to the first base station, and the third TVWS WBT is coupled to a second base station and configured to provide backhaul traffic for the second base station to the second base station. In aspects, allocating resources, by the scheduler of the first TVWS WBT, for communicating the backhaul traffic to at least a second TVWS WBT and a third TVWS WBT coupled to the first TVWS WBT includes assigning, by the scheduler, respective slots for communication by the second TVWS WBT and the third TVWS WBT. In aspects, the method 400 comprises communicating, by the scheduler of the first TVWS WBT, with the at least a second TVWS WBT and a third TVWS WBT coupled to the first TVWS WBT using a shared control channel. In aspects, the method 400 comprises monitoring, by the scheduler of the first TVWS WBT, the backhaul traffic load, wherein allocating resources for communicating the backhaul traffic includes allocating resources for communicating the backhaul traffic based on the monitoring of the backhaul traffic load. In aspects, the method 400 comprises allocating resources for communicating the backhaul traffic to at least the second TVWS WBT and the third TVWS WBT coupled to the first TVWS WBT based on input provided by a user using a user interface.

A flow chart of a particular embodiment of the presently disclosed method is depicted in FIG. 5. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language or hardware implementation. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 5, an example embodiment of a method 500 of backhaul traffic communication. The method 500 includes, as shown in processing block 502, receiving, via a first interface of a TVWS WBT, on a shared control channel, at least one of backhaul traffic or control frames from a centralized TVWS WBT. The centralized TVWS WBT communicates with a core network using Wi-Fi waveforms on one or more TVWS bands. Processing block 504 shows sending, via a second interface of the TVWS WBT, backhaul traffic to a base station coupled to the TVWS BT. In aspects, the centralized TVWS WBT uses the shared control channel to communicate with at least another TVWS WBT. In aspects, the method 500 comprises receiving, on the shared control channel an assignment of slots for the TVWS WBT to communicate, from the centralized TVWS WBT. In aspects, the method 500 comprises transmitting, via the first interface, on the shared control channel the backhaul needs of the TVWS WBT to the centralized TVWS WBT and receiving on the shared control channel a resource allocation to communicate the backhaul traffic to the base station based on such needs.

The protocols described herein have largely been adopted by the 3GPP as a standard for 5G network technology, and may also be for interfacing with 4G/LTE technology. For example, X2 is used in both 4G and 5G and is also complemented by 5G-specific standard protocols called Xn. Additionally, the 5G standard includes two phases, non-standalone (which will coexist with 4G devices and networks) and standalone, and also includes specifications for dual connectivity of UEs to both LTE and NR (“New Radio”) 5G radio access networks. The inter-base station protocol between an LTE eNB and a 5G gNB is called Xx. The specifications of the Xn and Xx protocol are understood to be known to those of skill in the art and are hereby incorporated by reference dated as of the priority date of this application.

In some embodiments, centralized nodes can be deployed as containerized architecture. In some embodiments, a centralized node can be as described in U.S. Provisional App. No. 63/499,239, and may have other capabilities other than TVWS-capable backhaul terminal coordination, including providing fronthaul or baseband processing. In some embodiments,

In some embodiments, several nodes in the 4G/LTE Evolved Packet Core (EPC), including mobility management entity (MME), MME/serving gateway (S-GW), and MME/S-GW are located in a core network. Where shown in the present disclosure it is understood that an MME/S-GW is representing any combination of nodes in a core network, of whatever generation technology, as appropriate. The present disclosure contemplates a gateway node, variously described as a gateway, HetNet Gateway, multi-RAT gateway, LTE Access Controller, radio access network controller, aggregating gateway, cloud coordination server, coordinating gateway, or coordination cloud, in a gateway role and position between one or more core networks (including multiple operator core networks and core networks of heterogeneous RATs) and the radio access network (RAN). This gateway node may also provide a gateway role for the X2 protocol or other protocols among a series of base stations. The gateway node may also be a security gateway, for example, a TWAG or ePDG. The RAN shown is for use at least with an evolved universal mobile telecommunications system terrestrial radio access network (E-UTRAN) for 4G/LTE, and for 5G, and with any other combination of RATs, and is shown with multiple included base stations, which may be eNBs or may include regular eNBs, femto cells, small cells, virtual cells, virtualized cells (i.e., real cells behind a virtualization gateway), or other cellular base stations, including 3G base stations and 5G base stations (gNBs), or base stations that provide multi-RAT access in a single device, depending on context.

One having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

In the present disclosure, the words “eNB,” “eNodeB,” and “gNodeB” are used to refer to a cellular base station. However, one of skill in the art would appreciate that it would be possible to provide the same functionality and services to other types of base stations, as well as any equivalents, such as Home eNodeBs. In some cases Wi-Fi may be provided as a RAT, either on its own or as a component of a cellular access network via a trusted wireless access gateway (TWAG), evolved packet data network gateway (ePDG) or other gateway, which may be the same as the coordinating gateway described hereinabove.

The word “X2” herein may be understood to include X2 or also Xn or Xx, as appropriate. The gateway described herein is understood to be able to be used as a proxy, gateway, B2BUA, interworking node, interoperability node, etc. as described herein for and between X2, Xn, and/or Xx, as appropriate, as well as for any other protocol and/or any other communications between an LTE eNB, a 5G gNB (either NR, standalone or non-standalone). The gateway described herein is understood to be suitable for providing a stateful proxy that models capabilities of dual connectivity-capable handsets for when such handsets are connected to any combination of eNBs and gNBs. The gateway described herein may perform stateful interworking for master cell group (MCG), secondary cell group (SCG), other dual-connectivity scenarios, or single-connectivity scenarios.

In some embodiments, the base stations described herein may be compatible with a Long Term Evolution (LTE) radio transmission protocol, or another air interface. The LTE-compatible base stations may be eNodeBs, or may be gNodeBs, or may be hybrid base stations supporting multiple technologies and may have integration across multiple cellular network generations such as steering, memory sharing, data structure sharing, shared connections to core network nodes, etc. In addition to supporting the LTE protocol, the base stations may also support other air interfaces, such as UMTS/HSPA, CDMA/CDMA2000, GSM/EDGE, GPRS, EVDO, other 3G/2G, legacy TDD, 5G, or other air interfaces used for mobile telephony. In some embodiments, the base stations described herein may support Wi-Fi air interfaces, which may include one of 802.11a/b/g/n/ac/ad/af/ah. In some embodiments, the base stations described herein may support 802.16 (WiMAX), or other air interfaces. In some embodiments, the base stations described herein may provide access to land mobile radio (LMR)-associated radio frequency bands. In some embodiments, the base stations described herein may also support more than one of the above radio frequency protocols, and may also support transmit power adjustments for some or all of the radio frequency protocols supported.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to 5G networks, LTE-compatible networks, to UMTS-compatible networks, or to networks for additional protocols that utilize radio frequency data transmission. Various components in the devices described herein may be added, removed, or substituted with those having the same or similar functionality. Various steps as described in the figures and specification may be added or removed from the processes described herein, and the steps described may be performed in an alternative order, consistent with the spirit of the invention.

This application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 11,102,791, “TV Whitespace Relay for Public Safety,” filed Apr. 1, 2019; U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Provisional App. No. 63/499,239, U.S. Pat. App. Pub. Nos. US20170273134A1, US20170127409A1, US20240007159A1 in their entirety for all purposes. Features and characteristics of and pertaining to the systems and methods described in the present disclosure, including details of the multi-RAT nodes and the gateway described herein, are provided in the documents incorporated by reference. This application also incorporates by reference the U.S. patent application having docket number PWS-72749US01, filed 2022 Aug. 16 with application Ser. No. 17/819,950 and title “4G/5G Open RAN CU-UP High Availability Solution”; the U.S. patent application having docket number PWS-72754US01, filed 2022 Dec. 19 with application Ser. No. 18/068,520 and title “CU-CP High Availability”; and the U.S. patent application having docket number PWS-72765US01, filed 2022 Dec. 29 with application Ser. No. 18/148,432 and title “Singleton Microservice High Availability.”

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure. Various components in the devices described herein may be added, removed, or substituted with those having the same or similar functionality. Various steps as described in the figures and specification may be added or removed from the processes described herein, and the steps described may be performed in an alternative order, consistent with the spirit of the invention, limited only by the following claims.

1. A first television white space (TVWS)-capable wireless backhaul terminal (TVWS-capable WBT), comprising:
a backhaul interface configured to receive backhaul traffic from a core network using Wi-Fi waveforms on one or more TVWS bands;
a scheduler configured to allocate resources for communicating the backhaul traffic to at least a second TVWS-capable WBT and a third TVWS-capable WBT coupled to the first TVWS-capable WBT;
wherein the second TVWS-capable WBT is coupled to first base station and configured to provide backhaul traffic for the first base station to the first base station, and the third TVWS-capable WBT is coupled to a second base station and configured to provide backhaul traffic for the second base station to the second base station.

2. The first TVWS-capable WBT of claim 1, wherein the backhaul interface is configured to support multiple radio access technologies (RATs) at once.

3. The first TVWS-capable WBT of claim 1, wherein allocate resources for communicating the backhaul traffic to at least a second TVWS-capable WBT and a third TVWS-capable WBT coupled to the first TVWS-capable WBT includes assign respective slots for communication by the second TVWS-capable WBT and the third TVWS-capable WBT.

4. The first TVWS-capable WBT of claim 1, wherein the scheduler is further configured to communicate with the at least a second TVWS-capable WBT and a third TVWS-capable WBT coupled to the first TVWS-capable WBT using a shared control channel.

5. The first TVWS-capable WBT of claim 1, wherein receive backhaul traffic from a core network includes receive backhaul traffic of different network operators from the core network.

6. The first TVWS-capable WBT of claim 1, wherein:
the scheduler is further configured to monitor the backhaul traffic load; and
allocate resources for communicating the backhaul traffic includes allocate resources for communicating the backhaul traffic based on the monitored backhaul traffic load.

7. The first TVWS-capable WBT of claim 1, wherein:
the second TVWS-capable WBT indicates its backhaul needs to the first TVWS-capable WBT; and
the scheduler is further configured to allocate resources for communicating the backhaul traffic to at least the second TVWS-capable WBT and the third TVWS-capable WBT coupled to the first TVWS-capable WBT based on such needs.

8. The first TVWS-capable WBT of claim 1, wherein the Wi-Fi waveform is a Wi-Fi 802.11af waveform.

9. The first TVWS-capable WBT of claim 1, wherein the scheduler is further configured to allocate resources for communicating the backhaul traffic to at least the second TVWS-capable WBT and the third TVWS-capable WBT coupled to the first TVWS-capable WBT based on input provided by a user using a user interface.

10. The first TVWS-capable WBT of claim 1, wherein:
the first base station includes an active antenna unit (AAU); and
the scheduler is further configured to allocate resources for communicating the backhaul traffic to at least the second TVWS-capable WBT and the third TVWS-capable WBT coupled to the first TVWS-capable WBT based on active monitoring of the AAU.

11. A television white space (TVWS)-capable wireless backhaul terminal (TVWS-capable WBT), comprising:
a first interface configured to receive, on a shared control channel, at least one of backhaul traffic or control frames from a centralized TVWS-capable WBT, wherein the centralized TVWS-capable WBT communicates with a core network using Wi-Fi waveforms on one or more TVWS bands; and
a second interface configured to send the backhaul traffic to a base station coupled to the TVWS-capable WBT.

12. The TVWS-capable WBT of claim 11, wherein the TVWS-capable WBT is integrated into the base station.

13. The TVWS-capable WBT of claim 11, wherein the base station includes an all-G distributed unit (DU) and an all-G centralized unit (CU).

14. The TVWS-capable WBT of claim 11, wherein the centralized TVWS-capable WBT uses the shared control channel to communicate with at least another TVWS-capable WBT.

15. The TVWS-capable WBT of claim 11, the first interface is further configured to receive, on the shared control channel an assignment of slots for the TVWS-capable WBT to communicate, from the centralized TVWS-capable WBT.

16. The TVWS-capable WBT of claim 11, wherein the first interface is further configured to:
transmit on the shared control channel the backhaul needs of the TVWS-capable WBT or the base station to the centralized TVWS-capable WBT; and
receive on the shared control channel a resource allocation to communicate the backhaul traffic to the base station based on such needs.

17. A method of coordinating backhaul traffic communication, comprising:
receiving, by a backhaul interface of a first television white space (TVWS)-capable wireless backhaul terminal (TVWS-capable WBT), Wi-Fi waveforms on one or more television white space (TVWS) bands including backhaul traffic from a core network;
allocating resources, by a scheduler of the first TVWS-capable WBT, for communicating the backhaul traffic to at least a second TVWS-capable WBT and a third TVWS-capable WBT coupled to the first TVWS-capable WBT;
wherein the second TVWS-capable WBT is coupled to a first base station and configured to provide backhaul traffic for the first base station to the first base station, and the third TVWS-capable WBT is coupled to a second base station and configured to provide backhaul traffic for the second base station to the second base station.

18. The method of claim 17, wherein allocating resources, by the scheduler of the first TVWS-capable WBT, for communicating the backhaul traffic to at least a second TVWS-capable WBT and a third TVWS-capable WBT coupled to the first TVWS-capable WBT includes assigning, by the scheduler, respective slots for communication by the second TVWS-capable WBT and the third TVWS-capable WBT.

19. The method of claim 17, further comprising communicating, by the scheduler of the first TVWS-capable WBT, with the at least a second TVWS-capable WBT and a third TVWS-capable WBT coupled to the first TVWS-capable WBT using a shared control channel.

20. The method of claim 17, further comprising:
monitoring, by the scheduler of the first TVWS-capable WBT, the backhaul traffic load;
wherein allocating resources for communicating the backhaul traffic includes allocating resources for communicating the backhaul traffic based on the monitoring of the backhaul traffic load.
